(19) United States
(12) Patent Application Publication
(10) Pub. No.: US 2026/0278827 A1
(43) Pub. Date: Sep. 17, 2026

(54) DEVICE AND METHOD FOR PROVIDING OBJECT IMAGE DATA

(71) Applicant: RESOLVE BIOSCIENCES GMBH, Monheim am Rhein (DE)

(72) Inventors: Andrei Tchernook, Limbach-Oberfrohna (DE); Cheng Frank Zhong, Düsseldorf (DE)

(21) Appl. No.: 19/470,002

(22) PCT Filed: Feb. 22, 2024
(86) PCT No.: PCT/EP2024/054520

§ 371 Date: Sep. 26, 2025

Related U.S. Application Data
(60) Provisional application No. 63/454,749, filed on Mar. 27, 2023.

(51) Int. Cl. G06T 7/73; G01N 21/64; G06T 5/50; G06T 7/00

(52) U.S. Cl. CPC G06T 7/73; G01N 21/6456; G06T 5/50; G06T 7/0002; G06T 2200/04; G06T 2207/10024; G06T 2207/10064; G06T 2207/20212; G06T 2207/30168

(57) ABSTRACT

The invention relates to a device for providing object image data of a sample object attached to an object carrier, especially for providing object image data for spatial transcriptomics of the sample object, wherein the device comprises an imaging unit that is configured to receive the object carrier and that comprises an optical system to apply a 3D imaging technique in one or more color coding channels, a bright field trans-illumination technique and a DAPI fluorescence 3D imaging technique in order to provide the object image data.

### CROSS REFERENCE TO RELATED APPLICATIONS

This is a US national phase application under 35 U.S.C. § 371 of international application no. PCT/EP 2024/054520, filed 22 Feb. 2024, which claims priority to U.S. application no. 63/454,749 filed 27 Mar. 2023; each application referenced in this paragraph is incorporated herein by reference in its entirety.

### FIELD OF THE INVENTION

The invention relates to a device for providing object image data of a sample object attached to an object carrier, especially for providing object image data for spatial transcriptomics of the sample object. Furthermore, the invention relates to an object carrier and to a system for providing object image data for spatial transcriptomics of the sample object. Finally, the invention relates to a computer program for operating a system comprising program code means for causing a computer to carry out said method.

### BACKGROUND OF THE INVENTION

Spatial resolution of analytes in complex sample objects, such as tissues, provide insights into the processes underlying biological function and morphology, such as cell fate and development, disease progression and detection, and cellular and tissue-level regulatory networks. In view of these fields of interest, an understanding of spatial patterns or other forms of relationships between analytes may provide valuable information on differential cell behavior. A high-resolution spatial mapping of analytes to their specific location within a region or subregion reveals spatial expression patterns of analytes, can provide relational data, and further implicates analyte network interactions relating to disease or other morphologies or phenotypes of interest, resulting in a holistic understanding of cells in their morphological context.

Spatial transcriptomics is a special field of said high-resolution spatial mapping and it describes the study of an organism's transcriptome, i.e. the sum of all of its RNA transcripts. A plurality of well-known methods is related to spatial transcriptomics.

It is well known to use 4′,6-diamidino-2-phenylindole (DAPI) as a fluorescent stain that binds strongly to adenine-thymine-rich regions in the DNA. Thereby complex sample objects can be studied via fluorescence microscopy, leading to the known DAPI fluorescence 3D imaging technique.

It is furthermore well known to provide the bright field trans-illumination technique for spatial transcriptomics, where light is transmitted through the sample object and a contrast in the respective image is caused by an attenuation of the transmitted light in dense areas of the sample object.

It is an object of the invention to provide an improved device and an improved method for providing object image data of a sample object, especially for providing object image data with an improved precision.

### SUMMARY OF THE INVENTION

According to a first aspect of the invention, a device for providing object image data of a sample object attached to an object carrier, especially for providing object image data for spatial transcriptomics of the sample object, is provided. The device comprises
an imaging unit that is configured to receive the object carrier and that comprises an optical system to apply a 3D imaging technique in one or more color coding channels, a bright field trans-illumination technique and a DAPI fluorescence 3D imaging technique in order to provide the object image data.

The device according to the first aspect of the invention provides improved object image data by providing different techniques to gain respective image data. Every technique provides respective characteristics of the sample object.

Preferably, the optical resolution while using the bright field trans-illumination technique and/or the DAPI fluorescence 3D imaging technique is equal or at least comparable to the optical resolution of the one or more color coding channels.

Possible structures of an imaging unit according to the first aspect of the invention are well known in the field of spatial transcriptomics and therefore not described in the following.

In general, a device that comprises more than one imaging unit, such as two imaging units, for providing the features according to the present invention are also regarded as a device according to the first aspect of the invention. In particular, the imaging unit according to the first aspect of the invention can comprise a plurality of sub-units for applying a respective imaging technique. Such sub-units might be arranged within a common housing.

In the following, embodiments of the device according to the first aspect of the invention will be described.

In a preferred embodiment according to the first aspect of the invention, the device further comprises
a processing unit that is arranged and configured to control the imaging unit such that a global coordinate system of an individual well on the object carrier is generated via the bright field trans-illumination technique, wherein the global coordinate system is based on a plurality of detectable fiducials of the object carrier, and the processing unit is further configured to provide a stitched overview image based on the bright field illumination technique and on the DAPI fluorescence 3D imaging technique and to provide an alignment of the stitched overview image and of the global coordinate system based on the detectable fiducials for allowing a precise position definition within the stitched overview image.

The device according to this embodiment allows an improved position definition, especially a precise position definition within the stitched overview image. This allows a precise study of biological and/or chemical aspects illustrated within the object image data. This embodiment is based on the finding that a combination of images provided with the bright field trans-illumination technique and with the DAPI fluorescence 3D imaging technique can be even further improved by using the global coordinate system to define a certain position as precisely as possible with respect to the object carrier, i.e. with respect to the fiducials of the object carrier. The coordinate system allows an elimination of mechanical tolerances arising in the multiple imaging steps, also described as cycles, of every region studied on the object carrier.

To enable said alignment, images provided by the bright field illumination technique and by the DAPI fluorescence 3D imaging technique are respectively included into individual tiles of a color coding process. In order to gain the precise position definition, the respective images can be compared to a corresponding part of the stitched overview image.

The detectable fiducials might be spots or the like that show a contrast in their color compared to their surrounding on the object carrier. There is at least one fiducial corresponding to one respective well on the object carrier. Preferably, the dimensions of those fiducials allow a definition of their respective position with an accuracy of at least 500 nm.

In a preferred embodiment of the device according to the first aspect of the invention, the imaging unit is configured to take images via the bright field trans-illumination technique and via the DAPI fluorescence 3D imaging technique in a plane that is essentially parallel to the object carrier, in particular in a plane that is essentially in a center of a respective sample object thickness. By taking an image in a defined center of the sample object with respect to its thickness, the most interesting region of the sample object with respect to spatial transcriptomics can be studied, i.e. a surrounding of the object sample can be mainly taken out of consideration.

In a particularly preferred embodiment according to the first aspect of the invention, the device comprises a processing unit and the processing unit is configured to provide a quality control based on the object image data. The processing unit according to this embodiment can be the same or a different processing unit as in one of the previously mentioned embodiments. This embodiment underlines that the different images provided by said different techniques can lead to different information that advantageously supports the quality control. In a variant of this embodiment the quality control comprises at least one of the following defects: a false positioning of the object carrier; an immersion liquid failure, such as bubbles in the immersion liquid; a coarse contamination; a sample object attachment defect; a sample object detachment; a sample object deformation during a long-time imaging procedure.

Bubbles in the immersion liquid might be detected as shadows or large area defects in images provided by the bright field trans-illumination technique. Furthermore, images of the fiducials provided by the bright field trans-illumination technique enable a detection of the false positioning of the object carrier for imaging. The images provided by the DAPI fluorescence 3D imaging technique enable a detection of object attachment defects and/or of the detachment of the sample object from the respective substrate of the object carrier during an imaging phase. Sample object deformations can be recognized within images provided by the bright field trans-illumination technique and/or by the DAPI fluorescence 3D imaging technique.

Preferably, the precise position definition according to at least one of the preceding claims is a position definition with an accuracy of at least 100 nm.

According to a second aspect, the invention relates to an object carrier for providing object image data for spatial transcriptomics of a sample object. The object carrier comprising
a number of individual wells arranged to attach the sample object and
the plurality of detectable fiducials.

The object carrier with its fiducials enables advantages of the device according to the first aspect of the invention, such as the embodiments that support an alignment with the global coordinate system. Thereby, the object carrier according to the second aspect of the embodiment shares some advantages of the device according to the first aspect of the invention.

Preferably, the dimensions of the detectable fiducials enable their position definition with an accuracy of at least 500 nm.

Preferably, the plurality of fiducials is at least detectable in the light channel used by the bright field trans-illumination technique.

According to a third aspect, the invention relates to a system, especially a system for providing object image data for spatial transcriptomics of a sample object. Said system comprises the device according to an embodiment of the first aspect of the invention and the object carrier according to the second aspect of the invention.

The system according to the third aspect of the invention shares the advantages of the device according to the first aspect of the invention.

According to a fourth aspect, the invention relates to a method for providing object image data of a sample object attached to an object carrier, especially for providing object image data for spatial transcriptomics of the sample object. The method comprising:
providing an optical system to apply a bright field trans-illumination technique and a DAPI fluorescence 3D imaging technique in order to provide the image data;
receiving the object carrier;
generating a global coordinate system of an individual well on the object carrier via the bright field trans-illumination technique, wherein the global coordinate system is based on a plurality of detectable fiducials of the object carrier;
providing first image data based on the bright field trans-illumination technique and providing second image data based on the DAPI fluorescence 3D imaging technique;
providing a stitched overview image based on the first image data and on the second image data and providing an alignment of the stitched overview image and of the global coordinate system based on the detectable fiducials for allowing a precise position definition within the stitched overview image; and
output the object image data based on the alignment of the stitched overview image data and of the global coordinate system.

The method according to the fourth aspect of the invention provides an alignment with the global coordinate system and thereby a method for providing a precise position definition. The steps of said method are preferably performed in the given order. The provision of first and/or second image data and the generation of the global coordinate system might be performed in a different order.

In a preferred variant of the method according to the fourth aspect of the invention, the method is further comprising the step
providing a quality control based on the object image data.

Possible details of such a quality control are given above with respect to an embodiment of the device according to the first aspect of the invention.

The method for providing a quality control based on the provided image data forms a further aspect of the invention independent from the alignment with respect to the global coordinate system. The image data of this embodiment may comprise the first image data, the second image data and/or data received via the 3D imaging technique in color coding channels.

According to a fifth aspect, the invention relates to a computer program for operating a system comprising program code means for causing a computer to carry out a method according to an embodiment of the fourth and/or of the further aspect of the embodiment. The computer which comprises the computer program may for instance form an integrated part of the device according to the first aspect and/or of the system according to the third aspect of the invention and be implemented as a microcontroller or microprocessor. In another embodiment, the computer forms an integrated part of a control unit that is spatially separated from the device of the system and configured to control this device and/or a number of further similar devices.

It shall be understood that the device according to the first aspect of the invention, the object carrier according to the second aspect of the invention, the system according to the third aspect of the invention, the method according to the fourth aspect of the invention, the method according to the further aspect of the invention and the computer program for operating a system according to the fifth aspect of the invention have similar or identical embodiments.

These and other aspects of the invention will be apparent from and elucidated with reference to the embodiments described hereinafter.

### BRIEF DESCRIPTION OF THE DRAWINGS

In the following drawings:

FIG. 1 shows a first embodiment of a device according to a first aspect of the invention; and

FIG. 2 shows a flow diagram of a first embodiment of a method according to a fourth aspect of the invention.

### DETAILED DESCRIPTION OF EMBODIMENTS

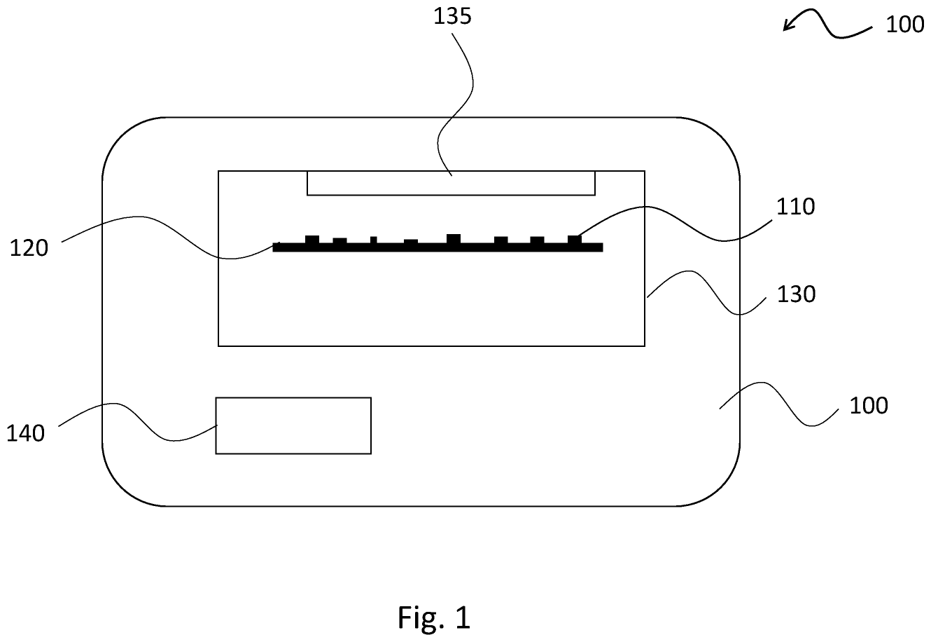

FIG. 1 shows a first embodiment of a device 100 according to a first aspect of the invention. The device 100 is configured for providing object image data of a sample object 110 attached to an object carrier 120, especially for providing object image data for spatial transcriptomics of the sample object 110. The device 100 comprises an imaging unit 130 that is configured to receive the object carrier 120 and that comprises an optical system 135 to apply a 3D imaging technique in one or more color coding channels, a bright field trans-illumination technique and a DAPI fluorescence 3D imaging technique in order to provide the object image data.

Furthermore, the device 100 comprises a processing unit 140 that is arranged and configured to control the imaging unit 130 such that a global coordinate system of an individual well on the object carrier 120 is generated via the bright field trans-illumination technique, wherein the global coordinate system is based on a plurality of detectable fiducials of the object carrier 120, and the processing unit 140 is further configured to provide a stitched overview image based on the bright field illumination technique and on the DAPI fluorescence 3D imaging technique and to provide an alignment of the stitched overview image and of the global coordinate system based on the detectable fiducials for allowing a precise position definition within the stitched overview image.

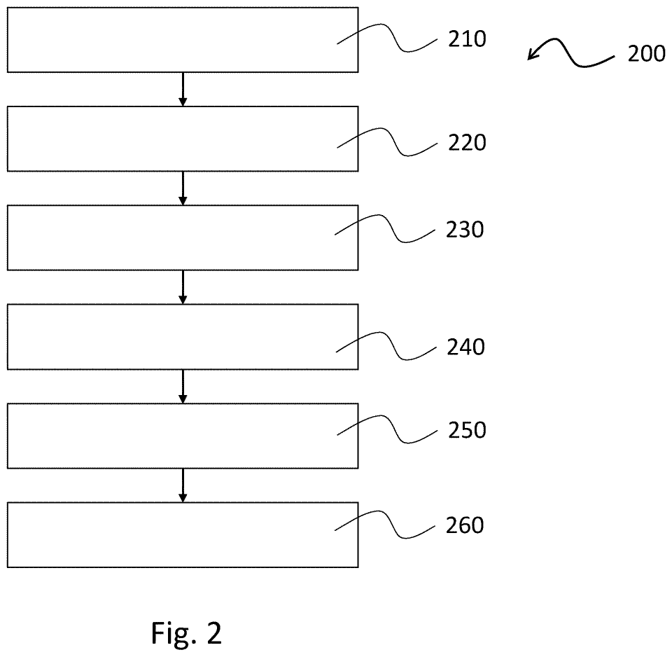

FIG. 2 shows a flow diagram of a first embodiment of a method 200 according to a fourth aspect of the invention.

The method 200 is configured for providing object image data of a sample object attached to an object carrier, especially for providing object image data for spatial transcriptomics of the sample object. The method 200 comprises steps as given in the following.

A first step 210 comprises a provision of an optical system to apply a bright field trans-illumination technique and a DAPI fluorescence 3D imaging technique in order to provide the image data.

A further step 220 comprises a reception of the object carrier.

A next step 230 comprises a generation of a global coordinate system of an individual well on the object carrier via the bright field trans-illumination technique, wherein the global coordinate system is based on a plurality of detectable fiducials of the object carrier.

A further step 240 comprises a provision of a first image data based on the bright field trans-illumination technique and a provision of a second image data based on the DAPI fluorescence 3D imaging technique.

A following step 250 comprises a provision of a stitched overview image based on the first image data and on the second image data and a provision of an alignment of the stitched overview image and of the global coordinate system based on the detectable fiducials for allowing a precise position definition within the stitched overview image.

A final step 260 comprises an output of the object image data based on the alignment of the stitched overview image data and of the global coordinate system.

Steps 230 and 240 can be performed in any order. The further steps are preferably performed in the given order.

1. A device for providing object image data of a sample object attached to an object carrier, especially for providing object image data for spatial transcriptomics of the sample object, wherein the device comprises an imaging unit that is configured to receive the object carrier and that comprises an optical system to apply a 3D imaging technique in one or more color coding channels, a bright field trans-illumination technique and a DAPI fluorescence 3D imaging technique in order to provide the object image data.

2. The device according to claim 1 further comprising a processing unit that is arranged and configured to control the imaging unit such that a global coordinate system of an individual well on the object carrier is generated via the bright field trans-illumination technique, wherein the global coordinate system is based on a plurality of detectable fiducials of the object carrier, and the processing unit is further configured to provide a stitched overview image based on the bright field illumination technique and on the DAPI fluorescence 3D imaging technique and to provide an alignment of the stitched overview image and of the global coordinate system based on the detectable fiducials for allowing a precise position definition within the stitched overview image.

3. The device according to claim 1, wherein the imaging unit is configured to take images via the bright field trans-illumination technique and via the DAPI fluorescence 3D imaging technique in a plane that is essentially parallel to the object carrier, in particular in a plane that is essentially in a center of a respective sample object thickness.

4. The device according to claim 1, wherein the processing unit is configured to provide a quality control based on the object image data.

5. The device according to claim 4, wherein the quality control comprises at least one of the following defects: a false positioning of the object carrier;
an immersion liquid failure, such as bubbles in the immersion liquid; a coarse contamination; a sample object attachment defect; a sample object detachment; a sample object deformation during a long-time imaging procedure.

6. The device according to claim 1, wherein the precise position definition is a position with an accuracy of at least 100 nm.

7. An object carrier for providing object image data for spatial transcriptomics of a sample object, the carrier comprising:
a number of individual wells arranged to attach the sample object; and
a plurality of detectable fiducials.

8. A system for providing object image data for spatial transcriptomics of a sample object, the system comprising:
the device according to claim 1; and
an object carrier for providing object image data for spatial transcriptomics of a sample object, the carrier comprising:
a number of individual wells arranged to attach the sample object; and
a plurality of detectable fiducials.

9. A method for providing object image data of a sample object attached to an object carrier, especially for providing object image data for spatial transcriptomics of the sample object, the method comprising:
providing an optical system to apply a bright field trans-illumination technique and a DAPI fluorescence 3D imaging technique in order to provide the image data;
receiving the object carrier;
generating a global coordinate system of an individual well on the object carrier via the bright field trans-illumination technique, wherein the global coordinate system is based on a plurality of detectable fiducials of the object carrier;
providing first image data based on the bright field trans-illumination technique and providing second image data based on the DAPI fluorescence 3D imaging technique;
providing a stitched overview image based on the first image data and on the second image data and providing an alignment of the stitched overview image and of the global coordinate system based on the detectable fiducials for allowing a precise position definition within the stitched overview image; and
output the object image data based on the alignment of the stitched overview image data and of the global coordinate system.

10. The method according to claim 9, further comprising providing a quality control based on the object image data.

11. A computer program for operating a system comprising program code means for causing a computer to carry out a method according to claim 9.
